(19) United States
(12) Patent Application Publication
(10) Pub. No.: US 2006/0204363 A1
(43) Pub. Date: Sep. 14, 2006

(54) Centrifugal blade unit of a cooling fan

(76) Inventors: Jun-Chien Yen, Shen Chen City (CN); Bor-Haw Chang Yang, Taipei (TW)

Correspondence Address: Jun-Chien Yen, 235 Chung-Ho, Box 8-24, Taipei, TW

(21) Appl. No.: 11/079,503

(22) Filed: Mar. 14, 2005

(51) Int. Cl. B64C 27/46

(52) U.S. Cl. 416/228

(57) ABSTRACT

A centrifugal blade unit of a cooling fan at least comprises a wheel hub and a plurality of fan blades connected around the circumference of the wheel hub, each having a first blade section and a second blade section that are either connected or bifurcated. Thereby, a reversed flow of a gaseous fluid through the fluid inlet of the cooling fan can be prevented.

### FIELD OF THE INVENTION

The present invention relates to blade structures of a fan, more particularly to a centrifugal blade unit of a fan for effectively cooling the circuit elements on a computer mother board.

### BACKGROUND OF THE INVENTION

Upon the rapid progress of the semi-conductor and information industries, new products of the industries are evolving to be of high frequency, high speed and light weight. The microminiaturization of electronic chips results in high heat generating density therein and therefore instability of their performance. Therefore, whether the heat produced in a chip can be effectively removed is a key point that determines whether a product is successful.

Because of lower heat generation density in the computer of prior art, the efficiency of a cooling system is not necessarily high. The addition of heat radiating components, such as thermosyphon, heat pipe and heat sink, are common. Based on economic and functional consideration, a mechanism composed of a fan and a heat sink is the most popular among those components. The blades of the fan is driven by an electric power device (such as a motor) to convert electric energy into the mechanical energy of the rotating blades which in turn activate gas circulation within the space to be cooled. Thereby, the heat conducted to the heat sink will be carried away by the air to the exterior of the computer. Therefore, the design and improvement of a fan of a cooling system is a key research issue.

The most common fans for a cooling system are classified into an axially flowing type and a centrifugal type. In a fan of the centrifugal type, the direction of the ejected gaseous fluid is radial and perpendicular to the axis of the fan hub. As the blades are rotating, a gaseous fluid is sucked into the fan through the central portion of a fan and acquires kinetic energy by a centrifugal interaction with the blades. Since the gaseous fluid flows in the radial direction along the blades, the shape of the blades influences the performance of the cooling fan. The configurations of the blades are further into three categories: (a) a forward curved type; (b) a radial type; and (c) a backward curved type. Since the pressure of the outflow driven by a fan of the centrifugal type is higher, it is used in systems of larger flow resistance. Further, because of the complexity of flow field within the fan, there will be phenomena of recirculation, reversed flow and separation, which all affect the cooling efficiency.

Referring to FIGS. 1 and 2, a centrifugal blade unit of a cooling fan of the prior art comprises a wheel hub 11 and a plurality of fan blades 12 connected around the circumference of the wheel hub 11. There are variations of the way the radial extension of the fan blades 12, such as the flat blades in FIG. 1, and the blades curved outwardly from the wheel hub in FIG. 2.

Referring to FIGS. 3 and 4, the fan is pivotally mounted within a case formed by an upper shell 13 and a lower shell. Each of the shells 13, 14 are respectively y provided with through holes 131 and 141. The combined upper shell 13 and lower shell define a worm pipe 15 for housing the wheel hub 11 and the fan blades 12. On one side of the shells 13, 14, there exists a fluid exit 16 connected to the worm pipe 25. Upon the operation of the wheel hub 11 and the fan blades 12, a gaseous fluid will be sucked into the case thorough the first through hole 131 and the second through hole 141 and will eject the gaseous fluid outwardly in the radial direction. Guided by the worm pipe 15, the ejected gaseous fluid will be driven out of the fluid exit 16.

However, since the fan blades 12 extend along the axial direction of the wheel hub 11, the air flows from the first through hole 131 and the second through hole 141 are expected to experience the same fan structure ideally. But, in reality, the inlet conditions at the first through hole 131 and the second through hole 141 are different; for example, the second through hole 141 situates adjacent to a plurality of supporting ribs. Therefore, when the flow resistance becomes higher at the fluid exit 16, the ejected flow will not completely go through the fluid exit 16, whereas a portion of the flow will be ejected backwardly from the first through hole 131 and the second through hole 141, not only reducing the inlet flow rate but also causing extra noises by the collision of the inlet flow and the reversed flow.

### SUMMARY OF THE INVENTION

Accordingly, the primary objective of the present invention is to provide a centrifugal blade unit of a cooling fan wherein a wheel hub is provided with a plurality of fan blades, each having a first blade section and a second blade section. The fan blades are uniformly arranged around the wheel hub for properly controlling the inflow pressure of a fluid so as to increase the fluid flow rate and reduce noises.

To achieve the above objective, a centrifugal blade unit of a cooling fan according to the present invention comprises a wheel hub and a set of fan blades connected around the hub. Each of the fan blades has a first blade section and a second section that are independently diverged from a common base section of a fan blade. The base sections, the first blade sections and the second blade sections take the shape of a sheet extended along the axial direction of the fan hub. In the first preferred embodiment, the first blade section and the second blade section of either fan blade are not connected.

In other preferred embodiments of the present invention, the fan blades are also arranged around the wheel hub, each having a first blade section and a second section that are diverged from a common base section of a fan blade in different directions. As in the first preferred embodiment, the first blade sections and the second blade sections are extended along the axial direction of the fan hub. However, the first blade section and the second blade section of either fan blade are connected through a transverse plate.

The various objects and advantages of the present invention will be more readily understood from the following detailed description when read in conjunction with the appended drawings.

### BRIEF DESCRIPTION OF THE DRAWINGS

FIG. 1 is a perspective view of a blade unit of a cooling fan of the prior art.

FIG. 2 is a perspective view of another blade unit of a cooling fan of the prior art.

FIG. 3 is an exploded view of the blade unit of a cooling fan of the prior art in FIG. 1 being confined in an upper shell and a lower shell.

FIG. 4 shows the blade unit of a cooling fan of the prior art in FIG. 1 being confined in an upper shell and a lower shell.

FIG. 5 is a lateral cross-sectional view of the blade unit of a cooling fan of the prior art in FIG. 1 being confined in an upper shell and a lower shell.

FIG. 6 is a perspective view of the first preferred embodiment of the present invention as a centrifugal blade unit of a cooling fan.

FIG. 7 is a top view of the first preferred embodiment of the present invention as a centrifugal blade unit of a cooling fan.

FIG. 8 is an exploded view of the first preferred embodiment of the present invention being confined in an upper shell and a lower shell.

FIG. 9 shows the first preferred embodiment of the present invention in FIG. 1 being confined in an upper shell and a lower shell.

FIG. 10 is a lateral cross-sectional view of the first preferred embodiment of the present invention being confined in an upper shell and a lower shell.

FIG. 11 is a top view of the first preferred embodiment of the present invention wherein the blades are in the second configuration.

FIG. 12 is a top view of the first preferred embodiment of the present invention wherein the blades are in the third configuration.

FIG. 13 is a perspective view of the second preferred embodiment of the present invention as a centrifugal blade unit of a cooling fan.

FIG. 14 is a radial cross-sectional view of the first blade section and the second blade section in the first configuration.

FIG. 15 is a radial cross-sectional view of the first blade section and the second blade section in the second configuration.

FIG. 16 is a radial cross-sectional view of the first blade section and the second blade section in the third configuration.

FIG. 17 is a perspective view of the third preferred embodiment of the present invention as a centrifugal blade unit of a cooling fan.

FIG. 18 is a top view of the third preferred embodiment of the present invention as a centrifugal blade unit of a cooling fan.

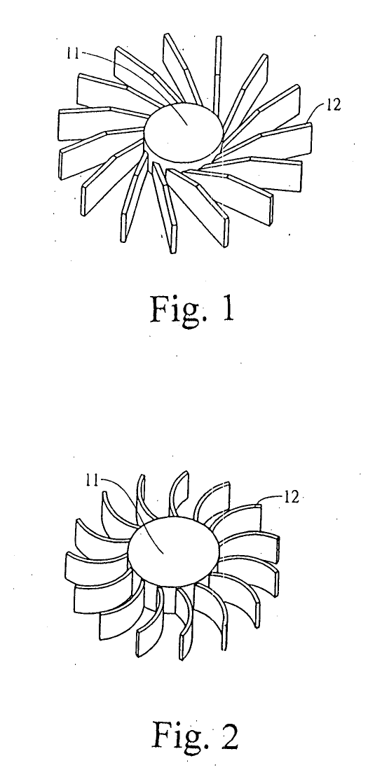

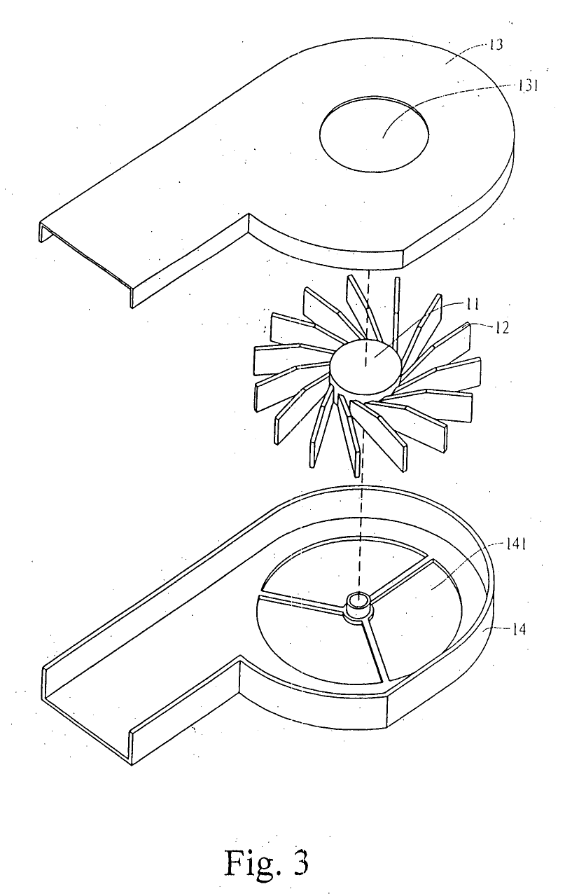

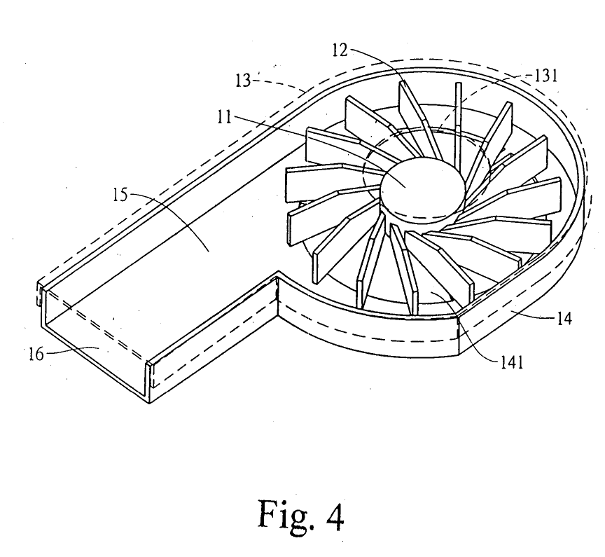

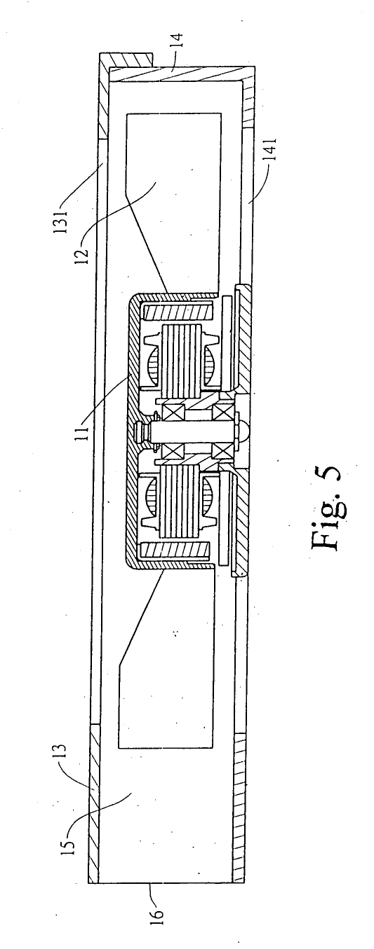

### DETAILED DESCRIPTION OF THE PREFERRED EMBODIMENTS

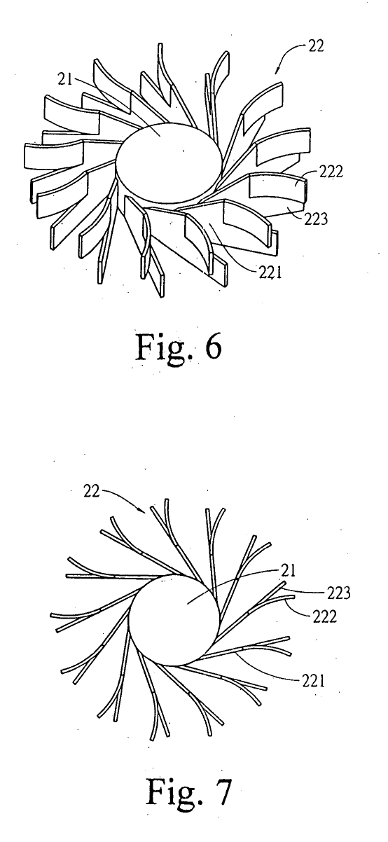

Referring to FIGS. 6 and 7, the first preferred embodiment of the present invention as a centrifugal blade unit of a cooling fan at least comprises a wheel hub 21 and a plurality of fan blades 22 connected around the circumference of the wheel hub 21. Each of the fan blades 22 has a base section 221, a first blade section 222 and a second blade section 223. In each of the fan blades 22, the first blade section 222 and the second blade section 223 are extended outwardly from the base section 221; the inward end of the base section 221 is connected to the wheel hub 21. In this preferred embodiment, the numbers of the first blade sections 222 and the second blade sections 223 are the same, and each pair of a first blade section 222 and a second blade section 223 do not connected. Further, in each pair of a first blade section 222 and a second blade section 223, they are arranged along the axis of the wheel hub 21 in an up-down configuration. In each pair of a first blade section 222 and a second blade section 223, the radial directions the first blade section 222 and the second blade section 223 extend are different, therefore the free end of a fan blade 22 appearing bifurcated.

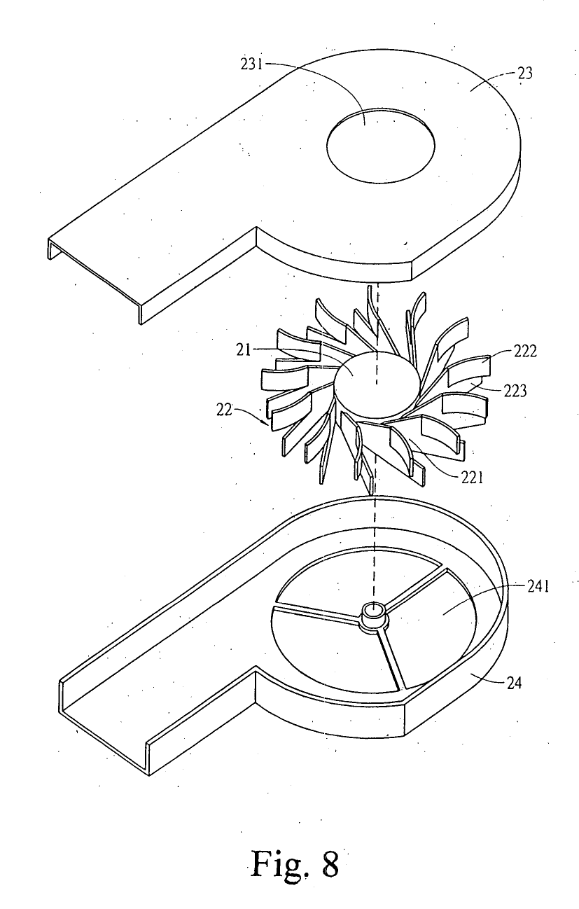

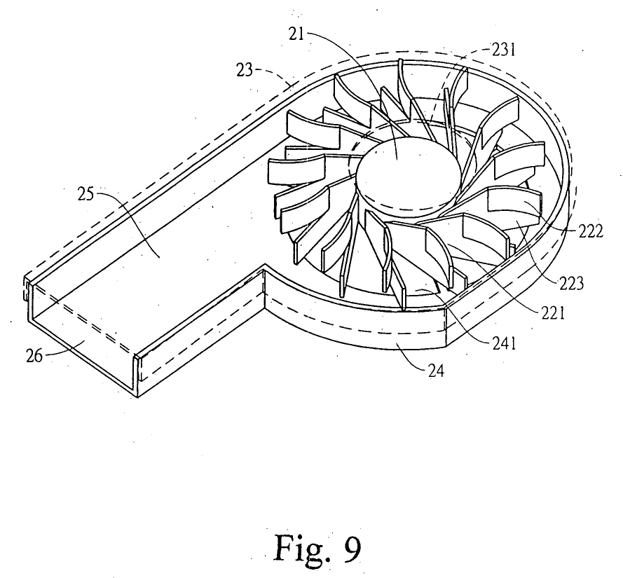

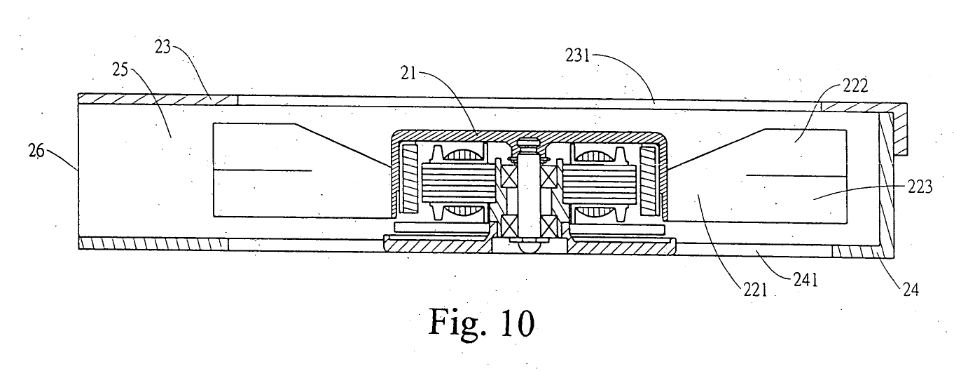

Referring to FIGS. 8, 9 and 10, the first preferred embodiment is pivotally mounted within a case composed of an upper shell 23 and a lower shell 24; the upper shell 23 includes a first through hole 231, and the lower shell 24 includes a second through hole 241. The inner space of the combined case body of the upper shell 23 and the lower shell 24 defines a worm pipe 25 for housing the wheel hub 21 and the fan blades 22 and an fluid exit 26 adjacent to the worm pipe 25, whereby the operation of the wheel hub 21 and the fan blades 22 will suck a gaseous fluid into the case thorough the first through hole 231 and the second through hole 241 and will thereby eject the gaseous fluid outwardly in the radial direction. Guided by the worm pipe 25, the ejected gaseous fluid will be driven out of the fluid exit 26. Because of the up-down arrangement and the bifurcated extension of each pair of a first blade section 222 and a second blade section 223, the first blade section 222 extends between the second blade section 223 and an adjacent second blade section 223, as viewed from the top. This configuration will prevents a reversed flow of the gaseous fluid from the fluid exit 26 to the first through hole 231 and the second through hole 241 due to large fluid resistance at the fluid exit 26, thereby reducing noises produced by the collision of the inflow and the reversed flow.

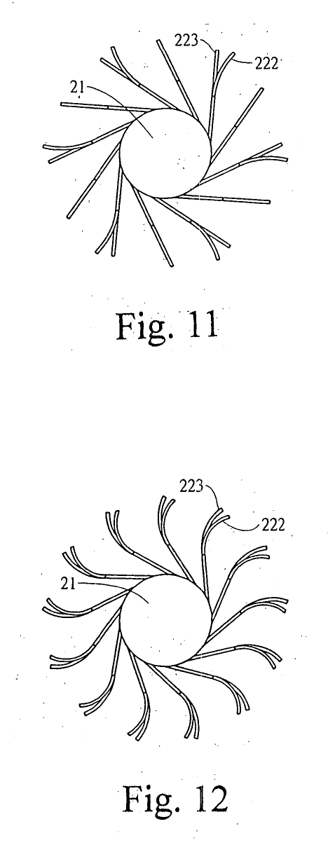

Further, the first blade sections 222 and the second blade sections 223 can differ in number (as shown in FIG. 11), thickness (not shown in the appended figures), the radial curving direction (as shown in FIG. 12), and the radial bending angle (not shown in the appended figures).

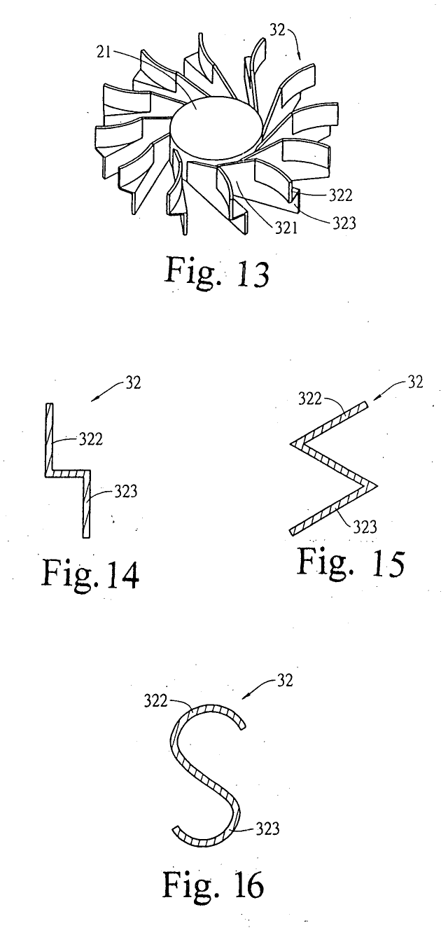

Referring to FIGS. 13, 14, 15 and 16, the second preferred embodiment of the present invention as a centrifugal blade unit of a cooling fan comprises the same components as the first preferred embodiment and exhibits the same functions. The difference between the first and the second preferred embodiments is that in the second preferred embodiment the first blade section 322 and the second blade section 323 extended from the base section 321 of each fan blade 32 are connected.

As shown by the cross-sectional views of a first blade section 322 and a second blade section 323 in FIGS. 15 and 16, the arrangement of the first blade section 322 and the second blade section 323 may form two opposite triangles along the wheel hub axis or two opposite arcs (the S-shaped contour shown) along the wheel hub axis.

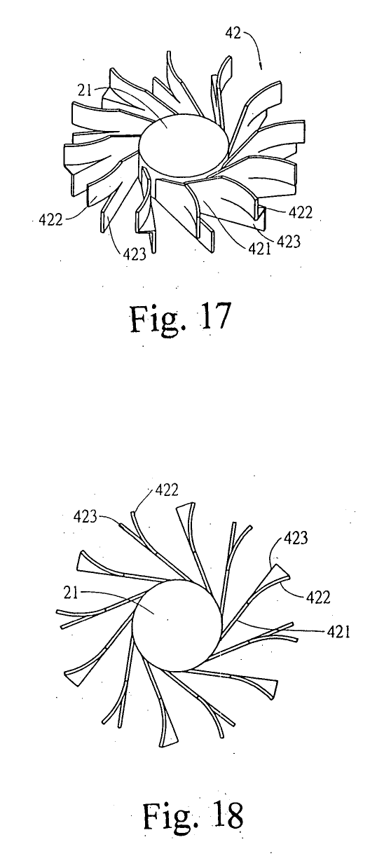

Referring to FIGS. 17 and 18, the third preferred embodiment of the present invention as a centrifugal blade unit of a cooling fan comprises the same components as the first preferred embodiment and exhibits the same functions. The difference between the first and the third preferred embodiments is that in the third preferred embodiment the first blade section 422 and the second blade section 423 of some fan blades 42 are connected, and the first blade section 422 and the second blade section 423 of other fan blades 42 are bifurcated and not connected.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A centrifugal blade unit of a cooling fan, comprising:
a wheel hub; and
a plurality of fan blades connected around a circumference of said wheel hub, each of said fan blades further comprising a first blade section and a second blade section, said first blade section and said second blade section of each said fan blade being bifurcated and not connected.

2. The centrifugal blade unit of a cooling fan of claim 1 wherein said first blade sections and said second blade sections are arranged along an axial direction of said wheel hub.

3. The centrifugal blade unit of a cooling fan of claim 1 wherein the number of said first blade sections and the number of said second blade sections are the same.

4. The centrifugal blade unit of a cooling fan of claim 1 wherein the number of said first blade sections and the number of said second blade sections are different.

5. The centrifugal blade unit of a cooling fan of claim 1 wherein the thickness of said first blade sections and the thickness of said second blade sections are the same.

6. The centrifugal blade unit of a cooling fan of claim 1 wherein the thickness of said first blade sections and the thickness of said second blade sections are different.

7. The centrifugal blade unit of a cooling fan of claim 1 wherein the radial bending angle of said first blade sections and the radial bending angle of said second blade sections are the same.

8. The centrifugal blade unit of a cooling fan of claim 1 wherein the radial bending angle of said first blade sections and the radial bending angle of said second blade sections are different.

9. The centrifugal blade unit of a cooling fan of claim 1 wherein the radial curving direction of said first blade sections and the radial curving direction of said second blade sections are the same.

10. A centrifugal blade unit of a cooling fan, comprising:
a wheel hub; and
a plurality of fan blades connected around a circumference of said wheel hub, each of said fan blades further comprising a first blade section and a second blade section, said first blade section and said second blade section of each said fan blade being connected.

11. The centrifugal blade unit of a cooling fan of claim 10 wherein said first blade sections and said second blade sections are arranged along an axial direction of said wheel hub.

12. The centrifugal blade unit of a cooling fan of claim 10 wherein the number of said first blade sections and the number of said second blade sections are the same.

13. The centrifugal blade unit of a cooling fan of claim 10 wherein the number of said first blade sections and the number of said second blade sections are different.

14. The centrifugal blade unit of a cooling fan of claim 10 wherein the thickness of said first blade sections and the thickness of said second blade sections are the same.

15. The centrifugal blade unit of a cooling fan of claim 10 wherein the thickness of said first blade sections and the thickness of said second blade sections are different.

16. The centrifugal blade unit of a cooling fan of claim 10 wherein the radial bending angle of said first blade sections and the radial bending angle of said second blade sections are the same.

17. The centrifugal blade unit of a cooling fan of claim 10 wherein the radial bending angle of said first blade sections and the radial bending angle of said second blade sections are different.

18. The centrifugal blade unit of a cooling fan of claim 10 wherein the radial curving direction of said first blade sections and the radial curving direction of said second blade sections are the same.

19. The centrifugal blade unit of a cooling fan of claim 10 wherein the radial curving direction of said first blade sections and the radial curving direction of said second blade sections are different.

20. A centrifugal blade unit of a cooling fan, comprising:
a wheel hub; and
a plurality of fan blades connected around a circumference of said wheel hub, each of said fan blades further comprising a first blade section and a second blade section, said first blade section and said second blade section of some said fan blades being connected, said first blade section and said second blade section of other said fan blades being bifurcated and not connected.
